(19) United States
(12) Patent Application Publication
(10) Pub. No.: US 2008/0092710 A1
(43) Pub. Date: Apr. 24, 2008

(54) Locking device for a rotary shaft of a table saw

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/584,007

(22) Filed: Oct. 20, 2006

(51) Int. Cl. B23D 19/00

(52) U.S. Cl. 83/478

(57) ABSTRACT

A locking device for a rotary wheel of a table saw includes a rotary shaft and a rotary wheel connected with a rear end of the rotary shaft. The shaft has a threaded end at its utmost rear end and a pivotally fitting section connected with the threaded end. A squeezing sleeve engaged with the rotary shaft is installed outside the table saw. The rotary wheel has a fixing hole for fixing with the pivotally fitting section, and a positioning knob located outside the rotary shaft for screwing with the threaded end so as to move axially to push the rotary wheel to squeeze the squeezing sleeve to keep the rotary wheel positioned immovably.

### BACKGROUND OF THE INVENTION

1. Field of the invention

This invention relates to a table saw, particularly to one provided with a locking device able to easily keep a rotary shaft positioned immovably.

2. Description of the Prior Art

As shown in FIG. 1, a rotary wheel 10 of a conventional table saw is composed of a shaft 11, a locking sleeve 12 and a locking rod 13. The shaft 11 fitted pivotally within the locking sleeve 12 is provided with a squeezing groove 111 cut at a preset location for fitting with a squeezing block 112, and an adjustment hole 113 dug axially at its center to communicate with the squeezing groove 111, for fitting with the locking rod 13. The locking rod 13 is provided with a squeezing cone 131 at its front end to contact with the squeezing block 112, and an external thread 132 threaded around its rear end for engaging correspondingly with an internal thread 114 formed on the rear wall of the adjustment hole 113. When the rotary wheel 10 is turned to stay at a position as desired, the locking rod 13 is turned to force the squeezing cone 131 to squeeze the squeezing block 112 to tightly contact with the interior wall of the locking sleeve 12, enabling the rotary wheel 10 positioned immovably.

But, the conventional rotary wheel 10 has disadvantages as described below. First, in assembly, the shaft 11 has to be fitted in the locking sleeve 12 primarily and then installed on the conventional table saw; next, engage the locking rod 13 with the adjustment hole 113, with assembling complicated. Second, the squeezing block 112 and the groove 111 are rather difficult to be made, relatively increasing manufacturing difficulty and cost. Third, if the locking rod 13 is screwed too deep in the adjustment hole 113 to keep the squeezing block 112 over tightened with the interior wall of the locking sleeve 12, it is hard to screw loosely the locking rod 13 or even unable to loose it, having to replace the rotary wheel 10 with a new one.

### SUMMARY OF THE INVENTION

The objective of this invention is to offer a locking device for a rotary wheel of a table saw.

The main characteristics of the invention are a rotary shaft and a rotary wheel connected with a rear end of the rotary shaft and installed outside the table saw. The rotary shaft, provided with a threaded end at its utmost rear end and a pivotally fitting section connected with the threaded end, is fitted in a squeezing sleeve that is installed outside the table saw and extended outward to cover slightly the pivotally fitting section. The rotary wheel is provided with a fixing hole for fixing with the pivotally fitting section, and a positioning knob located outside it for screwing with the threaded end so as to move axially to push the rotary wheel to squeeze the squeezing sleeve to keep the rotary wheel positioned immovably. Therefore, both of the rotary shaft and the rotary wheel have simple structures and a simple interaction, able to decrease manufacturing cost and advance assembling and maintenance efficiencies.

### BRIEF DESCRIPTION OF DRAWINGS

This invention is better understood by referring to the accompanying drawings, wherein:

FIG. 1 is cross-sectional view of a conventional locking device of a conventional table saw;

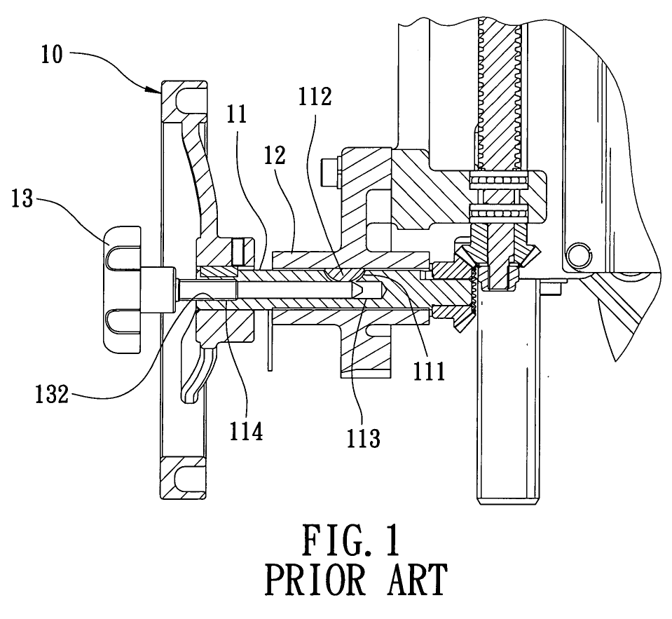

FIG. 2 is a perspective view of a first preferred embodiment of a locking device for a table saw in the present invention;

FIG. 3 is a partial perspective view of the first preferred embodiment of a locking device for a table saw in the present invention;

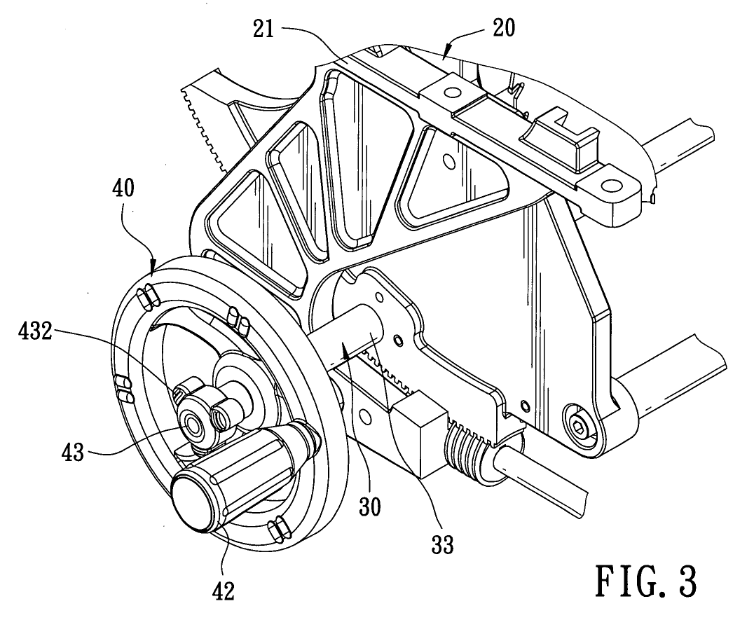

FIG. 4 is an exploded partial perspective view of the first preferred embodiment of a locking device for a table saw in the present invention;

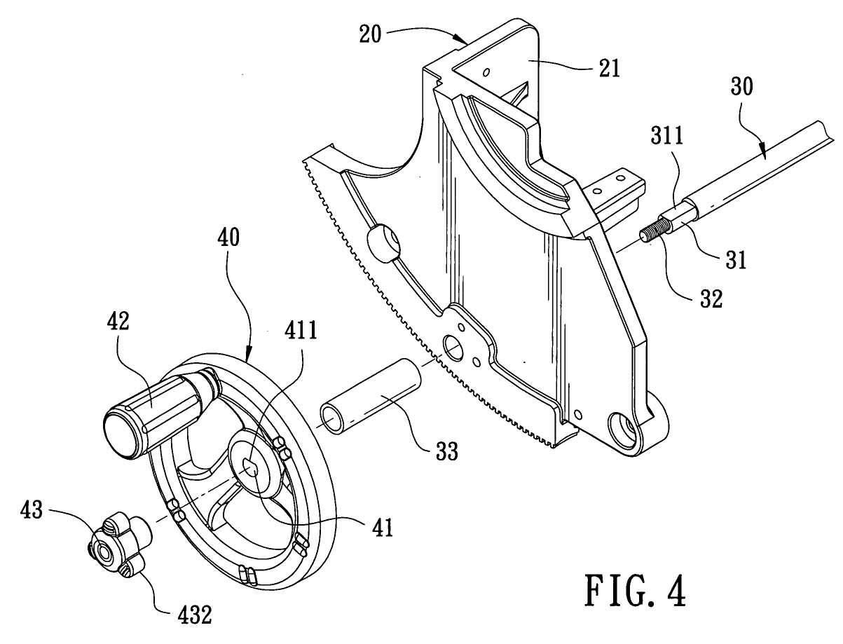

FIG. 5 is a cross-sectional view of the first preferred embodiment of a locking device for a table saw in the present invention, showing it being locked deadly;

FIG. 6 is a cross-sectional view of the first preferred embodiment of a locking device for a table saw in the present invention, showing it being loosened; and

FIG. 7 is a cross-sectional view of a second preferred embodiment of a locking device for a table saw in the present invention.

### DETAILED DESCRIPTION OF THE PREFERRED EMBODIMENT

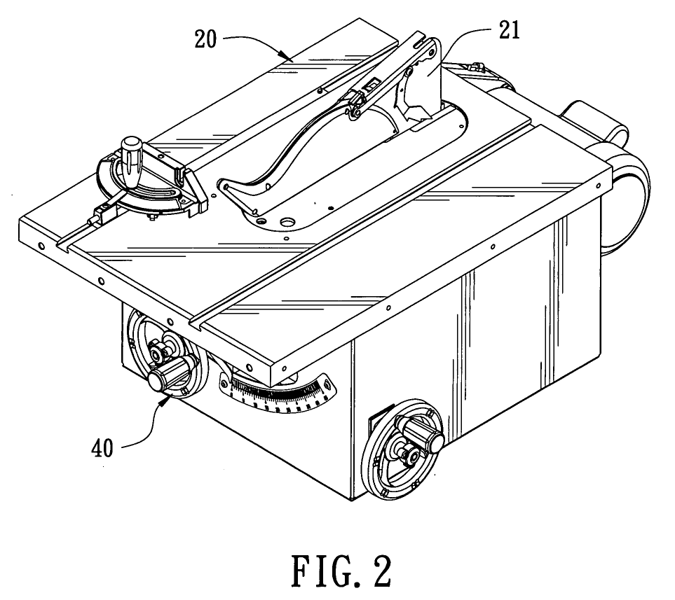

FIGS. 2˜5 show a preferred embodiment of a locking device for a rotary wheel of a table saw 20 in the present invention. The locking device is used to control a saw base 21 of the table saw 20 to rise up or down and to incline respectively, provided with a rotary shaft 30 and a rotary wheel 40 connected pivotally with an rear end of the rotary shaft 30 outside the table saw 20.

The rotary shaft 30 is provided with a threaded end 32 at its utmost rear end, a pivotally fitting section 31 connected with the threaded end 32, provided with a restricting flat surface 311. In addition, there is a squeezing sleeve 33 located outside the table saw 20 for the rotary shaft 30 to penetrate through. The rear end of the squeezing sleeve 33 is extended outwards to cover slightly the pivotally fitting section 31.

The rotary wheel 40 is provided with a fixing hole 41 cut at its center for fitting restrictively with the pivotally fitting section 31, having a restricting flat surface 411 corresponding with the restricting surface 311 so that the rotary wheel 40 is connected fixedly with the rotary shaft 30, enabling the rotary wheel 40 to drive the rotary shaft 30 simultaneously when turned around. The rotary wheel 40 is also provided with a grip 42 installed circumferentially for turning it easily, and a positioning knob 43 located outside it for engaging correspondingly with the threaded end 32. The positioning knob 43 is provided with a threaded hole 431 at its center for screwing axially together with the threaded end 32, and a preset number of projected swellings 432 around its circumference for turning it easily.

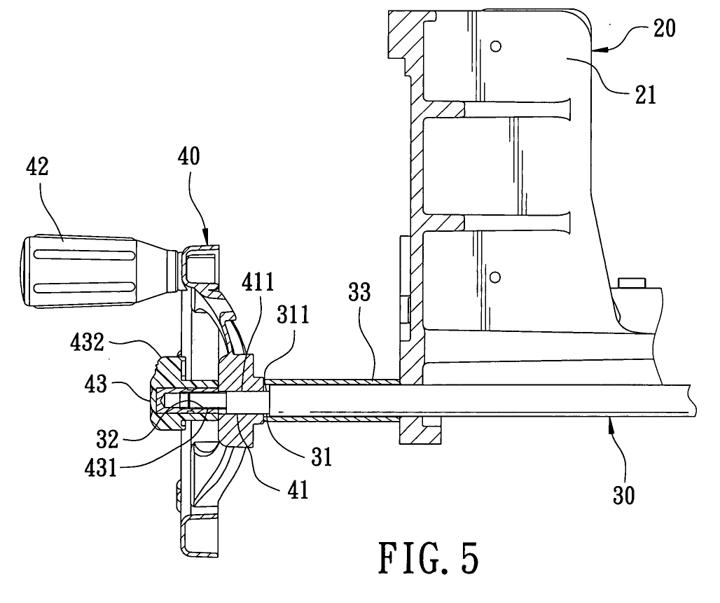

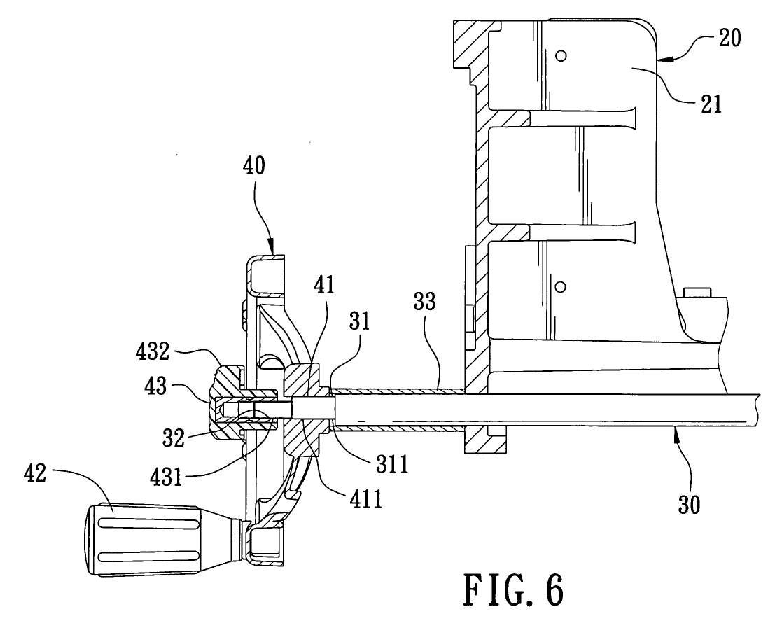

In using, as shown in FIG. 6, when the saw base 21 is to be adjusted for its level and angle inclined, the positioning knob 43 has to be screwed loosely so as to free the rotary wheel 40 for permitting the rotary shaft 30 to control the saw base 21 to move up or down and to incline. Next, as shown in FIG. 5, as the saw base 21 is moved to an expected position, the positioning knob 43 can be screwed toward the table saw 20 so that the rotary wheel 40 is to approach the squeezing sleeve 33 and to squeeze it until the rotary wheel 40 can not be rotated, keeping the saw base 21 compressed immovably by the rotary shaft 30.

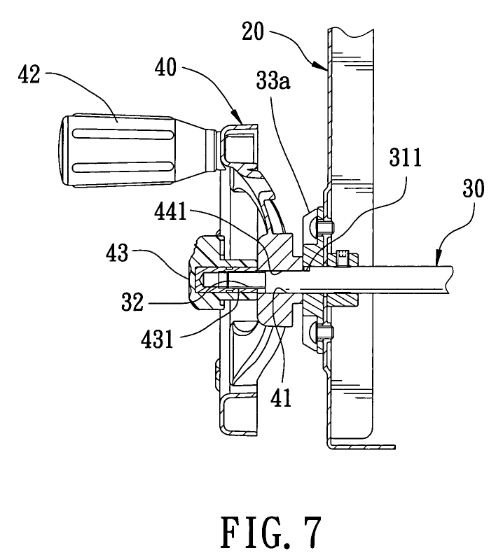

Additionally, a second preferred embodiment of the invention has the same parts as the first one does other than the squeezing sleeve 33a formed as a sheet instead of a sleeve in the first one, as shown in FIG. 7. The squeezing sleeve 33a also extended outwards to cover slightly the pivotally fitting section 31 is fixed deadly on an outer surface of the table saw 20 to prevent it from turning around in case of being over compressed.

The invention has the following advantages as can be seen from the foresaid description.

1. Both of the rotary shaft 30 and the rotary wheel 40 have simple structures and interact simply, able to decrease manufacturing cost and advance assembling and maintenance efficiencies.

While the preferred embodiment of the invention has been described above, it will be recognized and understood that various modifications may be made therein and the appended claims are intended to cover all such modifications that may fall within the spirit and scope of the invention.

What is claimed is:

1. A locking device for a rotary wheel of a table saw comprising:
a rotary shaft provided with a threaded end at its utmost rear end and a pivotally fitting section connected with said threaded end, a squeezing sleeve located outside said table saw and extended outwards to cover slightly said pivotally fitting section; and
a rotary wheel provided with a fixing hole cut at its center for fitting restrictively with said pivotally fitting section of said rotary shaft and a positioning knob located outside said rotary shaft for engaging correspondingly with said threaded end, said positioning knob able to screw axially to push said rotary wheel to squeeze said squeezing sleeve.

2. A locking device for a rotary wheel of a table saw as claimed in claim 1, wherein said threaded end is a threaded bar formed at the front of said engaging section for screwing correspondingly with a threaded hole of said positioning knob.

3. A locking device for a rotary wheel of a table saw as claimed in claim 1, wherein said pivotally fitting section is provided with a restricting flat surface shaped axially for fitting restrictively with a restricting flat surface defining said fixing hole of said rotary wheel.

4. A locking device for a rotary wheel of a table saw as claimed in claim 1, wherein said positioning knob is provided with a preset number of projected swellings around its circumference

5. A locking device for a rotary wheel of a table saw as claimed in claim 1, wherein said rotary wheel is provided with a grip installed circumferentially.
